(19) United States
(12) Patent Application Publication
(10) Pub. No.: US 2005/0148709 A1
(43) Pub. Date: Jul. 7, 2005

(54) Solid plant-protective formulations

(76) Inventors: Gerd Roland Meyer, Main (DE); Ralf Zerrer, Karlstein (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/499,997

(22) PCT Filed: Dec. 17, 2002
(86) PCT No.: PCT/EP02/14368

(30) Foreign Application Priority Data
Dec. 22, 2001 (DE) 101 63 901.5

(51) Int. Cl. C08J 3/00

(52) U.S. Cl. 524/127; 524/318; 524/379; 526/287; 526/242; 526/286; 526/310; 526/274; 526/319; 526/303.1; 526/265; 526/317.1; 526/346

(57) ABSTRACT

The invention relates to solid plant protection formulations comprising polymers based on acrylamidopropylmethylenesulfonic acid (AMPS) and “macromonomers”. The formulations are dispersible without a great stirring effort. In addition, the formulations have excellent stability on storage with regard to temperature variations and humidity (e.g., no caking). The invention is suitable in particular for wettable powders (WP) and water dispersible granules (WDG). The suspensions prepared from the solid formulations show a markedly increased suspensibility (ability to remain suspended) and stability.

The present invention relates to solid plant protection formulations, in particular wettable powders (WP) and water dispersible granules (WDG), comprising polymers based on acrylamidopropylmethylenesulfonic acid (AMPS) and “macromonomers”. The dispersibility of the formulations is markedly increased by the addition of the polymers. The aqueous suspensions for application prepared from the solid formulations have a markedly increased suspensibility (ability to remain suspended).

Solid plant protection formulations, when converted to/diluted in aqueous suspensions, frequently show only an unsatisfactory dispersibility. This problem occurs in particular in formulations comprising sparingly soluble hydrophobic pesticides. Common dispersing agents are polyvinylpyrrolidones, polyvinyl alcohols, phosphate esters, methoxycarbonylcellulose, methylcellulose, lignin sulfonate waste liquors, sulfonated naphthalene-formaldehyde condensates, starch and alginates.

It has now been found, surprisingly, that solid plant protection formulations comprising polymers based on acrylamidopropylmethylenesulfonic acid (AMPS) and “macromonomers” can be dispersed very well without a great stirring effort. In addition, the formulations exhibit excellent stability on storage with regard to temperature variations and humidity (e.g. no caking). The invention is suitable in particular for wettable powders (WP) and water dispersible granules (WDG). The suspensions prepared from the solid formulations show a markedly increased suspensibility (ability to remain suspended) of the components and an increased stability.

The present invention relates to solid plant protection formulations comprising at least one polymer which can be prepared by radical copolymerization of
A) acrylamidopropylmethylenesulfonic acid (AMPS) and/or its salts;
B) one or more macromonomers comprising
   i) a terminal group which is capable of polymerizing and which is at least partially soluble in the reaction medium,
   ii) a hydrophobic part which is hydrogen or a saturated or unsaturated, linear or branched, aliphatic, cycloaliphatic or aromatic (C₁-C₁₀₀)-hydrocarbon residue, and
   iii) optionally a hydrophilic part based on polyalkylene oxides; and
C) optionally one or more additional at least mono- or polyolefinically unsaturated oxygen-, nitrogen-, sulfur-, phosphorus-, chlorine- and/or fluorine-comprising comonomers.

The macromonomers B) preferably comprise a hydrophilic part based on polyalkoxides, preferably polyethylene oxides and/or polypropylene oxides.

Suitable salts of acrylamidopropylmethylenesulfonic acid (AMPS) are preferably the lithium, sodium, potassium, magnesium, calcium, ammonium, monoalkylammonium, dialkylammonium, trialkylammonium or tetraalkylammonium salts, the alkyl substituents of the ammonium ions being, independently of one another, (C₁-C₂₂)-alkyl residues which can carry 0 to 3 hydroxyalkyl groups, the alkyl chain length of which can vary within a range of from C₂ to C₁₀. Likewise suitable are mono- to triethoxylated ammonium compounds with a variable degree of ethoxylation. Salts which are particularly preferred are the sodium and ammonium salts. The degree of neutralization of the acrylamidopropylmethylenesulfonic acid (AMPS) is preferably 70 to 100 mol %.

The comonomer A) is preferably the sodium salt and/or ammonium salt of acrylamidopropylmethylenesulfonic acid (AMPS).

The macromonomers B) are preferably those of the formula (1)
R¹—Y—(R²—O)ₓ(R⁴—O)_{z}—R³ (1)
in which
R¹ is a vinyl, allyl, acryloyl (i.e. CH₂═CH—CO—), methacryloyl (i.e. CH₂═C(CH₃)—CO—), senecioyl or crotonyl residue;
R² and R⁴ are, independently of one another, (C₂-C₄)-alkylene;
x and z are, independently of one another, an integer between 0 and 500, preferably with x+z greater than or equal to 1;
Y is O, S, PH or NH, preferably O; and
R³ is hydrogen or a saturated or unsaturated, linear or branched, aliphatic, cycloaliphatic or aromatic (C₁-C₁₀₀)-hydrocarbon residue, preferably (C₁-C₃₀)-hydrocarbon residue.
R¹ is particularly preferably an acryloyl or methacryloyl residue.
R² and R⁴ are particularly preferably a C₂- or C₃-alkylene residue.
x and z are particularly preferably, independently of one another, a number between 0 and 50, preferably with x+z greater than or equal to 1. Particularly preferably, 5≦x+z≦50 applies.

R³ is particularly preferably an aliphatic (C₄-C₂₂)-alkyl or -alkenyl residue, preferably (C₁₀-C₂₂)-alkyl or -alkenyl residue;
a phenyl residue;
a (C₁-C₂₂)-alkylphenyl residue, preferably (C₁-C₉)-alkylphenyl residue, particularly preferably (C₁-C₄)-alkylphenyl residue, especially preferably sec-butyl- or n-butylphenyl residue;
a poly((C₁-C₂₂)-alkyl)phenyl residue, preferably poly((C₁-C₉)-alkyl)phenyl residue, particularly preferably poly((C₁-C₄)-alkyl)phenyl residue, especially preferably poly(sec-butyl)phenyl residue, very particularly preferably tris(sec-butyl)phenyl residue or tris(n-butyl)phenyl residue; or
a polystyrylphenyl residue [i.e. poly(phenylethyl)phenyl residue], particularly preferably tristyrylphenyl residue [i.e. tris(phenylethyl)phenyl residue].

Particular preference is given, as R³ residues, to 2,4,6-tris(1-phenylethyl)-phenyl residues and 2,4,6-tris(sec-butyl)phenyl residues.

The macromonomers B) are preferably prepared by reaction of reactive derivatives of unsaturated carboxylic acids, preferably of methacrylic acid or acrylic acid, with the corresponding, optionally alkoxylated, alkyl or aryl residues comprising hydroxyl groups. The ring-opening addition to the respective carboxylic acid glycidyl esters is also possible.

In a preferred embodiment, the polymers additionally comprise other olefinically unsaturated oxygen-, nitrogen-, sulfur-, phosphorus-, chlorine- and/or fluorine-comprising comonomers C).

Preference is given, as comonomers C), to olefinically unsaturated acids or their salts, preferably with mono- and divalent counterions, particularly preferably styrenesulfonic acid, vinylsulfonic acid, vinylphosphonic acid, allylsulfonic acid, methallylsulfonic acid, acrylic acid, methacrylic acid and/or maleic acid or maleic anhydride, fumaric acid, crotonic acid, itaconic acid or senecioic acid or their salts. Preferred counterions are Li⁺, Na⁺, K⁺, Mg²⁺, Ca²⁺, Al³⁺, NH₄⁺, monoalkylammonium, dialkylammonium, trialkylammonium and tetraalkylammonium ions, in which the substituents of the amines are, independently of one another, (C₁-C₂₂)-alkyl residues which can carry 0 to 3 hydroxyalkyl groups, the alkyl chain length of which can vary within the range C₂ to C₁₀. In addition, mono- to triethoxylated ammonium compounds with a variable degree of ethoxylation, and corresponding acid anhydrides (also mixed), can also be used the degree of neutralization of the optional olefinically unsaturated acids C) can be 0 to 100 mol %, preferably 70 to 100 mol %.

Also suitable as comonomers C) are esters of unsaturated carboxylic acids, preferably acrylic acid, methacrylic acid, styrenesulfonic acid, maleic acid, fumaric acid, crotonic acid and senecioic acid, with aliphatic, aromatic or cycloaliphatic alcohols with a carbon number of 1 to 30.

Suitable comonomers C) are likewise acyclic and cyclic N-vinylamides (N-vinyllactam) with a ring size of 4 to 9 atoms, preferably N-vinylformamide (NVF), N-vinylmethylformamide, N-vinylmethylacetamide (VIMA), N-vinylacetamide, N-vinylpyrrolidone (NVP), N-vinylcaprolactam; amides of acrylic acid and of methacrylic acid, particularly preferably acrylamide, N,N-dimethylacrylamide, N,N-diethylacrylamide, N,N-diisopropylacryl-amide; alkoxylated acrylamides and methacrylamides, preferably hydroxymethylmethacrylamide, hydroxyethylmethacrylamide and hydroxypropylmethacrylamide.

Likewise suitable are succinic acid mono[2-(methacryloyloxy)ethyl ester]; N,N-dimethylamino methacrylate; diethylaminomethyl methacrylate; acryl- and methacrylamidoglycolic acid; [2-(methacryloyloxy)ethyl]trimethylammonium chloride (MAPTAC) and [2-(acryloyloxy)ethyl]trimethylammonium chloride (APTAC); 2-vinylpyridine; 4-vinylpyridine; vinyl acetate; methacrylic acid glycidyl ester; acrylonitrile; vinyl chloride; vinylidene chloride; tetrafluoroethylene; diallyldimethylammonium chloride (DADMAC); stearyl acrylate; and/or lauryl methacrylate.

Also suitable are methylenebisacrylamide and methylenebismethacrylamide; esters of unsaturated mono- and polycarboxylic acids with polyols, e.g. diacrylates or triacrylates, such as butanediol diacrylate or dimethacrylate, ethylene glycol diacrylate or dimethacrylate, and trimethylolpropane triacrylate; allyl compounds, e.g. allyl(meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

Particular preference is given to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from methacrylic acid or acrylic acid, preferably methacrylic acid, and compounds of the formula (2)
   HO—(CH₂—CH₂—O)ₓ—R³ (2)
   in which x is a number between 0 and 50, preferably 1 and 50, particularly preferably 5 and 30, and
R³ is a (C₁₀-C₂₂)-alkyl residue; and
C) optionally one or more comonomers chosen from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

Particularly suitable as macromonomers B) are esters formed from acrylic acid or methacrylic acid and alkyl ethoxylates chosen from the group consisting of
(C₁₀-C₁₈)-fatty alcohol polyglycol ethers with 8 EO units (Genapol® C-080);
C₁₁-oxo alcohol polyglycol ethers with 8 EO units (Genapol® UD-080);
(C₁₂-C₁₄)-fatty alcohol polyglycol ethers with 7 EO units (Genapol® LA-070);
(C₁₂-C₁₄)-fatty alcohol polyglycol ethers with 11 EO units (Genapol® LA-110);
(C₁₆-C₁₈)-fatty alcohol polyglycol ethers with 8 EO units (Genapol® T-080);
(C₁₆-C₁₈)-fatty alcohol polyglycol ethers with 15 EO units (Genapol® T-150);
(C₁₆-C₁₈)-fatty alcohol polyglycol ethers with 11 EO units (Genapol® T-110);
(C₁₆-C₁₈)-fatty alcohol polyglycol ethers with 20 EO units (Genapol® T-200);
(C₁₆-C₁₈)-fatty alcohol polyglycol ethers with 25 EO units (Genapol® T-250);
(C₁₈-C₂₂)-fatty alcohol polyglycol ethers with 25 EO units;
iso(C₁₆-C₁₈)-fatty alcohol polyglycol ethers with 25 EO units; and
C₂₂-fatty alcohol polyglycol ethers with 25 EO units (Mergital® B 25).

In this connection, the EO units are ethylene oxide units. The Genapol® grades are products from Clariant and Mergital® B25 is a product from Cognis.

Particular preference is likewise given to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from acrylic acid or methacrylic acid, preferably methacrylic acid, and compounds of the formula (3)
   HO—(CH₂—CH₂—O)ₓ—R³ (3)
   in which x is a number between 0 and 50, preferably 1 and 50, particularly preferably 5 and 30, and
R³ is a poly((C₁-C₂₂)-alkyl)phenyl residue, preferably tris(sec-butyl)phenyl residue or tris(n-butyl)phenyl residue, particularly preferably 2,4,6-tris(sec-butyl)phenyl residue, or a tris(styryl)phenyl residue, preferably 2,4,6-tris(1-phenylethyl)phenyl residue; and
C) optionally one or more comonomers chosen from acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

The proportions by weight of the macromonomers B) in the polymer can vary between 0.1 and 99.9% by weight.

In a preferred embodiment, the polymers are highly hydrophobically modified, i.e. the proportion of macromonomers B) is 50.1 to 99.9% by weight, preferably 70 to 95% by weight, particularly preferably 80 to 94% by weight.

In another preferred embodiment, the polymers are poorly hydrophobically modified, i.e. the proportion of macromonomers B) is 0.1 to 50% by weight, preferably 5 to 25% by weight, particularly preferably 6 to 20% by weight.

The monomer distribution of the monomers A), B) and C) in the polymers can be alternating, random, gradient or block (also multiblock).

The number-average molecular weight of the polymers is preferably 1000 to 20 000 000 g/mol, preferably 20 000 to 5 000 000 g/mol, particularly preferably 50 000 to 1 500 000 g/mol.

In a preferred embodiment, the polymers are crosslinked, i.e. at least one crosslinking agent with at least two double bonds is copolymerized in the polymer.

Preferred crosslinking agents are methylenebisacrylamide and methylenebismethacrylamide; esters of unsaturated mono- or polycarboxylic acids with polyols, preferably diacrylates and triacrylates, e.g. butanediol diacrylate or dimethacrylate, ethylene glycol diacrylate or dimethacrylate, and trimethylolpropane triacrylate, allyl compounds, preferably allyl(meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

The polymers can be prepared by radical copolymerization, e.g. precipitation polymerization, emulsion polymerization, solution polymerization or suspension polymerization.

Particularly suitable are polymers prepared by precipitation polymerization, preferably in tert-butanol.

By the use of precipitation polymerization in tert-butanol, a specific particle size distribution of the polymers can be achieved in comparison with other solvents. The size distribution of the polymer particle can be determined, e.g., by laser diffraction or sieve analysis. The following particle size distribution is representative of a convenient size distribution, the particle size distribution being, as was determined by sieve analysis: 60.2% less than 423 micrometers, 52.0% less than 212 micrometers, 26.6% less than 106 micrometers, 2.6% less than 45 micrometers and 26.6% greater than 850 micrometers.

The polymerization reaction can be carried out in the temperature range between 0 and 150° C., preferably between 10 and 100° C., both at standard pressure and under increased or reduced pressure. As usual, the polymerization can also be carried out in a protective gas atmosphere, preferably under nitrogen.

The polymerization can be initiated by the use of high-energy electromagnetic radiation or the usual chemical polymerization initiators, e.g. organic peroxides, such as benzoyl peroxide, tert-butyl hydroperoxide, methyl ethyl ketone peroxide or cumene hydroperoxide, azo compounds, such as, e.g., azobisisobutyronitrile or azobisdimethylvaleronitrile, and inorganic peroxy compounds, such as, e.g., (NH₄)₂S₂O₈, K₂S₂O₈ or H₂O₂, optionally in combination with reducing agents, such as, e.g. sodium hydrogensulfite and iron(II) sulfate, or redox systems comprising, as reducing component, an aliphatic or aromatic sulfonic acid, such as, e.g., benzenesulfonic acid, toluenesulfonic acid or derivatives of these acids, such as, e.g., Mannich adducts from sulfinic acid, aldehydes and amino compounds.

The polymers have good solubility in water and are thermally stable. In particular, the adsorption behavior of the polymers with regard to water-insoluble active substances can be adjusted by the choice of the monomers, the monomer distribution and the degree of crosslinking. In addition, the Theological behavior of the suspensions prepared from the solid formulations can be controlled in this way.

The proportion of polymers is, based on the ready-mix formulations, preferably 0.01 to 25% by weight, particularly preferably 0.01 to 10% by weight, especially preferably 0.01 to 5% by weight, very particularly preferably 0.01 to 2.5% by weight.

The formulations are preferably wettable powders (WP) or water dispersible granules (WDG).

Wettable powders (WP) can be formulated in such a way that the pulverulent components are mixed, batchwise or continuously, in mixing devices generally equipped with rotary mixing elements, for example a plow-share mixer. The mixing times for a homogeneous mixture are generally between 30 seconds and 5 minutes, depending on the mixing device. Advantageously, the components are mixed with water to form a paste, dried (e.g. in tray, vacuum or fluid-bed driers) and converted to the pulverulent form in a mill or screening device.

Water dispersible granules (WDG) can be prepared by compacting pulverulent formulations, e.g. in roller compactors, and subsequently comminuting (e.g. with mills, tooth-disk rollers and/or sieves) to a particle size of 200 μm to 2 mm. In an additional embodiment, the pasty mixture can be subjected, with or without addition of a binder, to a shaping granulation through dies in an extruder but also through annular edge-runner presses, pan mills, optionally with an in-line spheronizer.

The formulations preferably comprise, in addition, at least one further dispersing agent.

The proportion of dispersing agents is, based on the ready-mix formulations, preferably 0.5 to 25% by weight, particularly preferably 0.5 to 10% by weight, especially preferably 0.1 to 5% by weight.

All conventional dispersing agents are suitable as dispersing agent.

Use is preferably made of phosphoric acid esters and their salts (e.g. potassium, sodium or triethanolamine salts) of fatty alcohols and their alkoxylates, preferably poly(arylalkyl)phenol polyethylene glycol phosphoric acid esters and tristyryl polyglycol ether phosphates; methoxycarbonyl-cellulose; methylcellulose; starch; alginates; sulfonated naphthalene-formaldehyde condensates; lignosulfonates, polyvinylpyrrolidone and/or polyvinyl alcohol.

In this connection, it has been found, surprisingly, that a synergistic effect occurs between the dispersing agents and the polymers which is manifest in that even a small amount of polymers, preferably 0.025 to 2.5% by weight, particularly preferably 0.025 to 1% by weight, is sufficient to markedly increase the dispersibility of the formulations.

The formulations comprise, as defined, at least one pesticide.

Suitable pesticides are preferably herbicides, insecticides, fungicides, acaricides, bactericides, molluscicides, nematicides and/or rodenticides.

The proportion of pesticides in the formulation is, based on the ready-mix formulations, 10 to 95% by weight, preferably 40 to 95% by weight, particularly preferably 60 to 95% by weight.

The invention is particularly advantageous for formulations comprising hydrophobic pesticides of low polarity. Such pesticides are sparingly soluble in water and therefore exhibit a particularly marked tendency to agglomerate.

Sparingly soluble pesticides have a solubility in water of less than 1 gram/liter. Readily soluble pesticides preferably have a solubility in water of more than 100 grams/liter, particularly preferably 500 grams/liter.

Mention may preferably be made, as sparingly soluble pesticides, of those from the class of the azoles, e.g. propiconazole(1-[2-(2,4-dichlorophenyl)-4-propyl-1,3-dioxolan-2-ylmethyl]-1H-1,2,4-triazole) and tebuconazole ((RS)-1-(p-chlorophenyl)-4,4-dimethyl-3-(1H-1,2,4-triazol-1-ylmethyl)pentan-3-ol), of the sulfonates, e.g. ethofumesate and benfuresate, of the anilides, e.g. propanil, of the phenylurea derivatives, e.g. monuron, diuron(N′-(3,4-dichlorophenyl)-N,N-dimethylurea) and amitrole, of the triazines, e.g. simazine and atrazine(6-chloro-N-ethyl-N′-(1-methylethyl)-1,3,5-triazine-2,4-diamine), of the tetrazines, e.g. clofentezine(3,6-bis(2-chlorophenyl)-1,2,4,5-tetrazine), of the propionic acid derivatives, e.g. dalapon, of the carbamates, e.g. pyrazolinate, tebuconazole, hexaconazole, phenmedipham(3-[(methoxycarbonyl)amino]phenyl(3-methylphenyl)carbamate) and desmedipham, of the thiocarbamates, of the alkylenebis(dithiocarbamates), e.g. maneb([1,2-ethanediylbis[carbamodithioato](2-)]manganese), mancozeb([[1,2-ethanediylbis[carbamodithioato]](2-)]manganese and [[1,2-ethanediylbis[carbamodithioato]](2-)]zinc), carbaryl(1-naphthyl methylcarbamate), azoxystrobin(methyl(E)-2-[[6-(2-cyanophenoxy)-4-pyrimidinyl]oxy]-α-(methoxymethylene)benzeneacetate), linuron, trifluralin, metsulfuron-methyl(methyl 2-[[[[(4-methoxy-6-methyl-1,3,5-triazin-2-yl)amino]carbonyl]amino]sulfonyl]benzoate), triasulfuron(2-(2-chloro-ethoxy)-N-[[(4-methoxy-6-methyl-1,3,5-triazin-2-yl)amino]carbonyl]-benzenesulfonamide), tribenuron-methyl(methyl2-[[[[(4-methoxy-6-methyl-1,3,5-triazin-2-yl)methylamino]carbonyl]amino]sulfonyl]benzoate) and chlorsulfuron(2-chloro-N-[[(4-methoxy-6-methyl-1,3,5-triazin-2-yl)amino]-carbonyl]benzenesulfonamide), of the halophthalonitriles, e.g. chlorothalonil (2,4,5,6-tetrachloro-1,3-dicyanobenzene), copper hydroxide and diflubenzuron(N-[[(4-chlorophenyl)amino]carbonyl]-2,6-difluorobenzamide).

In a preferred embodiment, the formulations comprise mixtures of at least one pesticide which is sparingly soluble in water and at least one pesticide which is readily soluble in water, preferably chosen from glyphosate, sulfosate and glufosinate. The sparingly soluble and readily soluble pesticides become compatible with one another due to the presence of the polymers.

The formulations can comprise, as auxiliaries/additives, inter alia, surface-active agents (adjuvants), disintegrating agents, thickeners, antifreeze agents, evaporation retardants, preservatives, antigelling agents and neutralizing agents.

The proportion of surface-active agents is, based on the ready-mix formulations, preferably 10 to 50% by weight, particularly preferably 20 to 40% by weight.

Suitable surface-active agents are preferably addition products of 2 to 30 mol of ethylene oxide and/or 0 to 5 mol of propylene oxide with linear fatty alcohols with 8 to 22 carbon atoms, with fatty acids with 12 to 22 carbon atoms, with mono-, di- and/ortrialkyl phenols with 8 to 15 carbon atoms in the alkyl group or with (C₈-C₁₈)-alkylamines; secondary ether amines and alkoxylated secondary ether amine derivatives; (C₁₂-C₁₈)-fatty acid mono- and diesters of addition products of 1 to 30 mol of ethylene oxide with glycerol; glycerol mono- and diesters and sorbitan/sorbitol mono- and diesters of saturated and unsaturated fatty acids with 6 to 22 carbon atoms and their ethylene oxide addition products; addition products of 15 to 60 mol of ethylene oxide with castor oil and/or hydrogenated castor oil; polyol and in particular polyglycerol esters, e.g. polyglycerol polyricinoleate and polyglycerol poly(12-hydroxystearate); carboxamides, e.g. decanoic acid dimethylamide; high-molecular-weight silicone compounds, e.g. dimethylpolysiloxanes with an average molecular weight of 10 000 to 50 000 g/mol.

Also suitable are anionic surfactants, e.g. alkali metal and ammonium salts of linear or branched alkyl(ene) sulfates with 8 to 22 carbon atoms, (C₁₂-C₁₈)-alkylsulfonic acids and (C₁₂-C₁₈)-alkylarylsulfonic acids; bis(phenolsulfonic acid) ethers and their alkali metal or ammonium salts, isethionates, preferably cocoyl isethionate; naphthalenesulfonic acid and/or sulfosuccinates.

Suitable disintegrating agents are water-soluble inorganic salts, e.g. NaCl and nitrate salts, water-soluble organic compounds, e.g. urea, and water-swellable materials.

In addition, the formulations can comprise solid carriers, fillers or diluents. Preference is given to clays, bentonites, silica gels, calcium and magnesium silicates, titanium dioxide, aluminum, calcium and magnesium carbonate, ammonium, sodium, potassium, calcium and barium sulfate, carbon, starch, modified starch, cellulose and/or cellulose derivatives.

The plant protection formulations according to the invention can be dispersed quickly without a great stirring effort. In addition, they have excellent stability on storage with regard to temperature variations and humidity (e.g. no caking). The aqueous suspensions prepared from the solid formulations show a markedly increased suspensibility and an increased stability.

The following examples are intended to illustrate the subject-matter of the invention in greater detail, without however limiting it thereto.

The suspensibility (ability to remain suspended) of the suspensions prepared from the solid formulations was determined according to the CIPAC methods MT 15.1 (WP) and MT174 (WDG) and is defined as the percentage by weight of the suspended materials to the total weight of all materials.

### EXAMPLE 1

### Polymer 1

500 g of toluene were introduced into a 1 l Quickfit flask equipped with a stirrer, an internal thermometer, gas inlet pipes for nitrogen and ammonia gas, and a reflux condenser. In addition, 3.0 g of 2-acrylamido-2-methylpropanesulfonic acid (AMPS) were introduced and were neutralized with the equivalent amount of ammonia. Subsequently, 60.0 g of stearyl acrylate and 30.0 g of isopropanol were added. The contents of the flask were rendered inert with nitrogen while stirring and were heated to 70° C. using a heating bath.

After reaching the temperature, 3.0 g of AIBN were added as initiator and the mixture was heated to 80° C. with further flushing with nitrogen. The mixture was stirred at reflux at the stated temperature for 4 h. After the reaction was complete, the product was transferred to a rotary evaporator in order to remove the solvent by vacuum distillation at approximately 50° C.

### EXAMPLE 2

### Polymer 2

Analogous procedure as in example 1. In place of stearyl acrylate, 28.0 g of a macromonomer, prepared by the reaction of acrylic acid with (C₁₂-C₁₄)-fatty acid polyglycol ethers with 7 ethylene oxide units, were added.

### EXAMPLE 3

### Fluometuron Wettable Powders (WP)

a) without polymer, with dispersing agent

| Composition: | % by weight |
|---|---|
| Fluometuron (97.2%) | 82.30 |
| Kaolin, Bolgar ® | 11.70 |
| Hostapon TPH ® | 4.00 |
| Wetting Agent IS ® | 2.00 |

The suspensibility (CIPAC MT 15.1) of the suspension prepared therefrom was 80%.

b) without polymer, with increased proportion of dispersing agent

| Composition: | % by weight |
|---|---|
| Fluometuron (97.2%) | 82.30 |
| Kaolin, Bolgar ® | 8.70 |
| Hostapon TPHC ® | 7.00 |
| Wetting Agent IS ® | 2.00 |

The suspensibility (CIPAC MT 15.1) of the suspension prepared therefrom was 84%.

c) with polymer 1 and dispersing agent

| Composition: | % by weight |
|---|---|
| Fluometuron (97.2%) | 82.30 |
| Kaolin, Bolgar ® | 11.70 |
| Polymer 1 from ex. 1 | 0.10 |
| Hostapon TPHC ® | 3.90 |
| Wetting Agent IS ® | 2.00 |

The suspensibility (CIPAC MT 15.1) of the suspension prepared therefrom was 92%.

d) with polymer 2 and dispersing agent

| | |
|---|---|
| Composition: | % by weight |

| | |
|---|---|
| Fluometuron (97.2%) | 82.30 |
| Kaolin, Bolgar ® | 11.70 |
| Polymer 2 from ex. 2 | 0.10 |
| Hostapon TPHC ® | 3.90 |
| Wetting Agent IS ® | 2.00 |

The suspensibility (CIPAC MT 15.1) of the suspension prepared therefrom was 96%.

e) with polymer, without dispersing agent

| Composition: | % by weight |
|---|---|
| Fluometuron (97.2%) | 82.30 |
| Kaolin, Bolgar ® | 11.70 |
| Polymer 2 from ex. 2 | 4.00 |
| Wetting Agent IS ® | 2.00 |

The suspensibility (CIPAC MT 15.1) of the suspension prepared therefrom was 85%.

The examples show that the suspensibility of the suspensions prepared from the wettable powders (WP) was markedly increased by addition of the polymers. In addition, the stability of the suspensions was increased. It is obvious in particular that, when polymers and dispersing agents are used simultaneously, an even very small amount of polymers markedly increases the suspensibility (see in this connection ex. 3 c) and 3 d)).

The wettable powders themselves could, by addition of polymer, be dispersed faster and with less stirring effort than the formulations without polymer.

Chemical description of the commercial products used:

| | |
|---|---|
| Hostapon TPHC ® | Sodium salt of an oleoyl methyl tauride |
| Wetting Agent IS ® | Sodium salt of a fatty alcohol monosuccinate |
| Kaolin, Bolgar ® | Bentonite |

1. A solid plant protection formulation comprising at least one polymer prepared by radical copolymerization of
A) acrylamidopropylmethylenesulfonic acid (AMPS) and/or its salts;
B) one or more macromonomers according to formula (1)
R¹—Y—(R²—O)ₓ(R⁴—O)_{z}—R³ (1)
wherein
R¹ is a vinyl, allyl, acryloyl, methacryloyl, senecioyl or crotonyl residue;
R² and R⁴ are, independently of one another, (C₂-C₄)-alkylene;
x and z are, independently of one another, an integer between 0 and 500, with x+z greater than or equal to 1;
Y is O, S, PH or NH; and
R³ is hydrogen or a saturated or unsaturated, linear or branched, aliphatic, cycloaliphatic or aromatic (C₁-C₁₀₀)-hydrocarbon residue, and
C) optionally one or more additional at least mono- or polyolefinically unsaturated oxygen-, nitrogen-, sulfur-, phosphorus-, chlorine- and/or fluorine-containing comonomers.

2. A solid plant protection formulation as claimed in claim 1, wherein the comonomer A) is the sodium salt and/or ammonium salt of acrylamidopropylmethylenesulfonic acid (AMPS).

3. A solid plant protection formulation as claimed in claim 1, wherein
R¹ is an acryloyl or methacryloyl residue;
R² and R⁴ are, independently of one another, C₂-alkylene or C₃-alkylene;
x and z are, independently of one another, an integer between 0 and 50, with x+z greater than or equal to 1;
R³ is an aliphatic (C₄-C₂₂)-alkyl or -alkenyl residue,
a phenyl residue;
a (C₁-C₂₂)-alkylphenyl residue,
a poly((C₁-C₂₂)-alkyl)phenyl residue, or
a polystyrylphenyl residue.

4. A solid plant protection formulation as claimed in claim 3, wherein the R³ residue is a 2,4,6-tris(sec-butyl)phenyl residue or 2,4,6-tris(1-phenylethyl)phenyl residue.

5. A solid plant protection formulation as claimed in claim 1, wherein the at least one polymer is prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid;
B) one or more macromonomers selected from the group consisting of esters formed from methacrylic acid or acrylic acid, and compounds of the formula (2)
HO—(CH₂—CH₂—O)ₓ—R³ (2)
in which x is a number between 1 and 50, and
R³ is a (C₁₀-C₂₂)-alkyl residue; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

6. A solid plant protection formulation as claimed in claim 1, wherein the one or more macromonomers B) are esters formed from acrylic acid or methacrylic acid or alkyl ethoxylates selected from the group consisting of
(C₁₀-C₁₈)-fatty alcohol polyglycol ethers with 8 EO units,
C₁₁-oxo alcohol polyglycol ethers with 8 EO units,
(C₁₂-C₁₄)-fatty alcohol polyglycol ethers with 7 EO units,
(C₁₂-C₁₄)-fatty alcohol polyglycol ethers with 11 EO units,
(C₁₆-C₁₈)-fatty alcohol polyglycol ethers with 8 EO units,
(C₁₆-C₁₈)-fatty alcohol polyglycol ethers with 15 EO units,
(C₁₆-C₁₈)-fatty alcohol polyglycol ethers with 11 EO units,
(C₁₆-C₁₈)-fatty alcohol polyglycol ethers with 20 EO units,
(C₁₆-C₁₈)-fatty alcohol polyglycol ethers with 25 EO units,
(C₁₈-C₂₂)-fatty alcohol polyglycol ethers with 25 EO units,
iso(C₁₆-C₁₈)-fatty alcohol polyglycol ethers with 25 EO units and
C₂₂-fatty alcohol polyglycol ethers with 25 EO units.

7. A solid plant protection formulation as claimed in claim 1, wherein the at least one polymer is prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid;
B) one or more macromonomers selected from the group consisting of esters formed from methacrylic acid or acrylic acid, and compounds of the formula (3)
HO—(CH₂—CH₂—O)ₓ—R³ (3)
wherein x is a number between 1 and 50, and
R³ is a poly((C₁-C₂₂)-alkyl)phenyl residue or a tris(styryl)phenyl residue; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

8. A solid plant protection formulation as claimed in claim 1, wherein the proportion of macromonomers B) in the at least one polymer is 50.1 to 99.9% by weight.

9. A solid plant protection formulation according to claim 1, wherein the proportion of macromonomers B) in the at least one polymer is 0.1 to 50% by weight.

10. A solid plant protection formulation as claimed in claim 1, wherein the number-average molecular weight of the at least one polymer is 1000 to 20 000 000 g/mol.

11. A solid plant protection formulation as claimed in claim 1, wherein the at least one polymer is crosslinked.

12. A solid plant protection formulation as claimed in claim 1, wherein the radical copolymerization is a precipitation polymerization reaction.

13. A solid plant protection formulation as claimed in claim 1, wherein the proportion of the at least one polymer, based on a ready-mix formulation, is 0.01 to 25% by weight.

14. A solid plant protection formulation as claimed in claim 1, wherein the solid plant protection formulation is a wettable powder (WP) or a water dispersible granule (WDG).

15. A solid plant protection formulation as claimed in claim 1, further comprising at least one dispersing agent.

16. A solid plant protection formulation as claimed in claim 15, wherein the proportion of the at least one polymer and at least one dispersing agent, based on a ready-mix formulation, is 0.5 to 25% by weight.

17. A solid plant protection formulation as claimed in claim 15, wherein the at least one dispersing agent is selected from the group consisting of phosphoric acid esters, phosphoric acid ester salts of fatty alcohols and their alkoxylates, and mixtures thereof.

18. A solid plant protection formulation as claimed in claim 1, further comprising at least one pesticide selected from the group consisting of herbicides, insecticides, fungicides, acaricides, bactericides, molluscicides, nematicides and rodenticides.

19. A solid plant protection formulation as claimed in claim 18, wherein the proportion of the at least one pesticide, based on the ready-mix formulation, is 10 to 95% by weight.

20. A solid plant protection formulation as claimed in claim 1, further comprising at least one pesticide which is sparingly soluble in water.

21. A solid plant protection formulation as claimed in claim 1, further comprising at least one pesticide which is sparingly soluble in water and at least one pesticide which is readily soluble in water.

22. A solid plant protection formulation as claimed in claim 1, further comprising at least one additive selected from the group consisting of surface-active agents, disintegrating agents, thickeners, antifreeze agents, evaporation retardants, preservatives, antigelling agents and neutralizing agents.

23. A solid plant protection formulation as claimed in claim 1, further comprising at least one compound selected from the group consisting of solid carriers, fillers and diluents.

24. A solid plant protection formulation as claimed in claim 1, wherein 5≦x+z≦50.

25. A solid plant protection formulation as claimed in claim 1, wherein Y is oxygen.

26. A solid plant protection formulation as claimed in claim 1, wherein R³ is a (C₁-C₁₀₀)-hydrocarbon residue.

27. A solid plant protection formulation as claimed in claim 3, wherein R³ is a (C₁₀-C₂₂)-alkyl or -alkenyl residue.

28. A solid plant protection formulation as claimed in claim 3, wherein R³ is sec-butyl- or n-butylphenyl residue.

29. A solid plant protection formulation as claimed in claim 3, wherein R³ is tris(sec-butyl)-phenyl residue or tris(n-butyl)phenyl residue.

30. A solid plant protection formulation as claimed in claim 3, wherein R³ is tristyrylphenyl residue.

31. A solid plant protection formulation as claimed in claim 5, wherein the comonomer A) is the ammonium salt of acrylamidopropylmethylenesulfonic acid.

32. A solid plant protection formulation as claimed in claim 5, wherein the one or more macromonomers is an ester formed from methacrylic acid.

33. A solid plant protection formulation as claimed in claim 5, wherein x is a number between 5 and 30.

34. A solid plant protection formulation as claimed in claim 7, wherein the comonomer A) is the ammonium salt of acrylamidopropylmethylenesulfonic acid.

35. A solid plant protection formulation as claimed in claim 7, wherein the one or more macromonomers is an ester formed from methacrylic acid.

36. A solid plant protection formulation as claimed in claim 7, wherein R³ is tris(sec butyl)phenyl residue.

37. A solid plant protection formulation as claimed in claim 7, wherein R³ is 2,4,6 tris(sec butyl)phenyl residue.

38. A solid plant protection formulation as claimed in claim 7, wherein R³ is 2,4,6 tris(1-phenylethyl)phenyl residue.

39. A solid plant protection formulation as claimed in claim 1, wherein the proportion of macromonomers B) in the at least one polymer 70 to 95% by weight.

40. A solid plant protection formulation as claimed in claim 1, wherein the proportion of macromonomers B) in the at least one polymer is 80 to 94% by weight.

41. A solid plant protection formulation as claimed in 1, wherein the proportion of macromonomers B) in the at least one polymer is 5 to 25% by weight.

42. A solid plant protection formulation as claimed in claim 1, wherein the proportion of macromonomers B) in the at least one polymer is 6 to 20% by weight.

43. A solid plant protection formulation as claimed in claim 1, wherein the number-average molecular weight of the at least one polymer is 50 000 to 1 500 000 g/mol.

44. A solid plant protection formulation as claimed in claim 1, wherein the number-average molecular weight of the at least one polymer is 50 000 to 1 500 000 g/mol.

45. A solid plant protection formulation as claimed in claim 12, wherein the precipitation reaction occurs in tert-butanol.

46. A solid plant protection formulation as claimed in claim 15, wherein the proportion of the at least one polymer and the at least dispersing agent, based on a ready mix formulation, is 0.5 to 10% by weight.

47. A solid plant protection formulation as claimed in claim 15, wherein the at least one dispersing agent is selected from the group consisting of poly(arylalkyl)phenol polyethylene glycol phosphoric acid esters, tristyryl polyglycol ether phosphates, methoxycarbonylcellulose, methylcellulose, starch, alginates, sulfonated naphthalene-formaldehyde condensates, lignosulfonates polyvinylpyrrolidone and polyvinyl alcohol.

48. A solid plant protection formulation as claimed in claim 18, wherein the proportion of the at least one pesticide, based on a ready-mix formulation, is 40 to 95% by weight.
